(19) United States
(12) Patent Application Publication
(10) Pub. No.: US 2022/0037699 A1
(43) Pub. Date: Feb. 3, 2022

(54) Propylene Carbonate-Based Electrolyte For Lithium Ion Batteries With Silicon-Based Anodes

(71) Applicant: Apple Inc., Cupertino, CA (US)

(72) Inventors: Hyea Kim, Campbell, CA (US); OuJung Kwon, Cupertino, CA (US); Woo Cheol Shin, Cupertino, CA (US)

(21) Appl. No.: 17/130,088

(22) Filed: Dec. 22, 2020

Related U.S. Application Data
(60) Provisional application No. 63/057,568, filed on Jul. 28, 2020.

(51) Int. Cl. H01M 10/0569; H01M 10/0525; H01M 4/38; H01M 10/0568; H01M 10/0567

(52) U.S. Cl. CPC H01M 10/0569; H01M 10/0525; H01M 2004/027; H01M 10/0568; H01M 10/0567; H01M 4/386

(57) ABSTRACT

An electrochemical cell has an anode comprising a silicon-based active material, a cathode comprising a cathode active material, and an electrolyte having no ethylene carbonate. The electrolyte comprises a solvent, the solvent being 20 wt % to 50 wt % propylene carbonate with the remainder being a linear solvent, a lithium salt, and less than 15 wt % of one or more additives. The silicon-based anode active material has a specific capacity of ≥700 mAh/g.

### CROSS-REFERENCE TO RELATED APPLICATION

This application claims priority to and the benefit of U.S. Provisional Application Patent Ser. No. 63/057,568, filed Jul. 28, 2020, the entire disclosure of which is hereby incorporated by reference.

### TECHNICAL FIELD

This disclosure relates to propylene carbonate-based electrolytes for lithium ion batteries having silicon-based anodes, the electrolytes having no ethylene carbonate.

### BACKGROUND

The use of lithium ion batteries has grown, and particularly, the use of lithium ion batteries using silicon-based anode material. Silicon is used as anode material in lithium ion batteries because silicon has a high theoretical capacity, providing batteries with improved energy density. Although the energy density of lithium ion batteries has increased with the use of silicon-based anode material, the silicon-based material has limited cycle life due to the large volume changes that silicon-based materials undergo during battery cycling. These large volume changes, as large as 300%-400%, can result in fracture of silicon particles, isolated fragments of particles that no longer contribute to capacity, and a weak solid-electrolyte interphase (SEI) prone to cracking and delamination. This limited cycle life prevents wider application of the technology.

### SUMMARY

Disclosed herein are implementations of propylene carbonate-based electrolytes having no ethylene carbonate for use with silicon-based anodes that provide, in the electrochemical cell, a specific capacity of greater than or equal to 700 mAh/g.

An electrochemical cell as disclosed herein has an anode comprising a silicon-based active material, a cathode comprising a cathode active material, and an electrolyte having no ethylene carbonate. The electrolyte comprises a solvent, the solvent being 20 wt % to 50 wt % propylene carbonate with the remainder being a linear solvent. The electrolyte further comprises a lithium salt and less than 15 wt % of one or more additives. The silicon-based anode active material has a specific capacity of ≥700 mAh/g.

Another electrochemical cell as disclosed herein comprises an anode having a silicon-based active material having a specific capacity of ≥700 mAh/g, a cathode comprising a cathode active material, and an electrolyte. The electrolyte consists of a solvent, the solvent being 20 wt % to 50 wt % propylene carbonate, with the remainder being a linear solvent; lithium salt selected from the group consisting of LiPF₆, LiPF₆ and LiFSI, or LiPF₆ and LiTFSI, the lithium salt having a molar concentration of 0.7 M to 1.5 M; and less than 15 wt % of one or more additives.

The linear solvent in the electrolytes disclosed herein can be one or a combination of diethyl carbonate, dimethyl carbonate or ethyl methyl carbonate.

The linear solvent in the electrolytes disclosed herein can be one or a combination of propyl propionate or ethyl propionate.

The additives in the electrolytes disclosed herein are selected from the group consisting of fluoroethylene carbonate, vinylene carbonate, an oxalate-based additive, and a nitrile-based additive.

Another electrochemical cell as disclosed herein has an anode comprising a silicon-based active material, a cathode comprising a cathode active material, and an electrolyte having no ethylene carbonate. The electrolyte comprises a solvent, the solvent being 30 wt % propylene carbonate and 70 wt % diethyl carbonate, 1.15 M LiPF₆, and less than 15 wt % of one or more additives, wherein the silicon-based anode active material has a specific capacity of ≥700 mAh/g.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a graph of discharge capacity versus number of cycles comparing the electrolyte disclosed herein against conventional electrolytes, comparing silicon and graphite anodes as well.

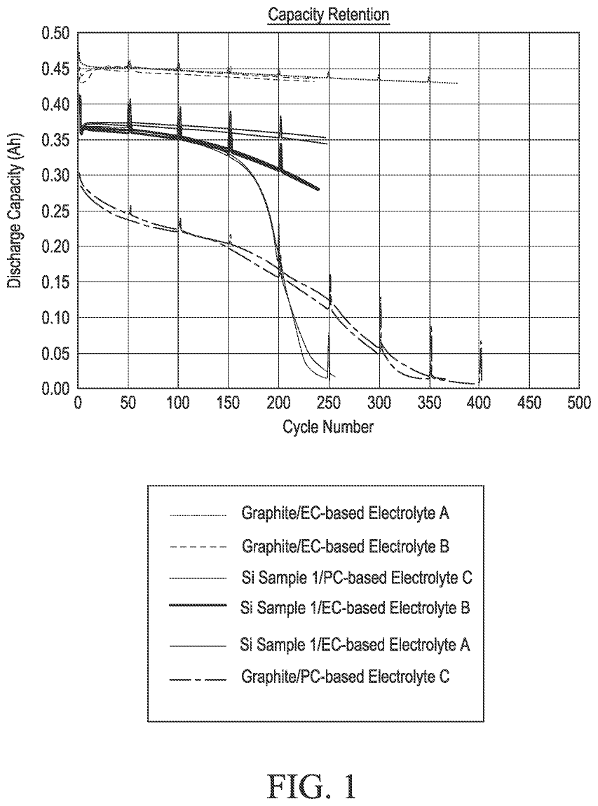

FIG. 2 is a cross-sectional view of an electrochemical cell as disclosed herein.

### DETAILED DESCRIPTION

Silicon-based materials are used as anode active material in lithium ion batteries because silicon has a high theoretical capacity, providing batteries with improved energy density. Although the energy density of lithium ion batteries has increased with the use of silicon-based anode material, the silicon-based material has limited cycle life due to the large volume changes that silicon experiences during battery cycling. These large volume changes, as large as 300%-400%, can result in, as one example, a weakened solid-electrolyte interphase (SEI) prone to cracking and delamination when conventional electrolytes are used.

The SEI is formed by the decomposition of organic and inorganic compounds during cycling, such organic and inorganic compounds components of the liquid electrolyte used in the lithium ion batteries. Conventional electrolytes made with common solvents, such as ethylene carbonate (EC), work well with graphite anodes, forming a passivation layer that allowing lithium transport while preventing further reduction of the bulk electrolyte. However, EC-based electrolytes are intrinsically less stable with silicon. The structure of the SEI generated from the EC solvent cannot accommodate the repetitive and extensive swelling of the silicon in the anode during cycling. Attempts have been made to address these issues by the introduction of additives. However, it has been found that additives at most delay the unavoidable decay of performance of such batteries. Once the additives are depleted, the fading of cell capacity occurs quickly. With this underlying incapability between the electrolyte and the silicon of the anode, the addition of functional molecules as additives to either or both the electrolyte and the anode material does not solve the degradation of the SEI interface, only postpones it.

Disclosed herein are electrolytes using propylene carbonate (PC)-based solvents. These electrolytes having PC as a solvent without any EC are showing improved performance in lithium ion batteries with silicon-based anodes over conventional liquid electrolytes using EC as a solvent. With conventional electrolytes such as those using EC as a solvent, for example, the decay rate of silicon gradually increases, leading to an accelerating decay trend. In comparison, the decay trend is reduced when the conventional solvent is replaced with a PC-based solvent. It is found that the decay rate of the lithium ion battery using a PC-based electrolyte decreases, projecting a much longer cycle life. This change of decay behavior can be significant. Using PC as a solvent, and eliminating EC as a solvent, results in less damage to the silicon in the anode during cycling. The PC-based electrolytes disclosed herein generate less resistance than conventional EC-based electrolytes because PC has fewer reductive reactions with silicon than EC has. PC has a lower melting point than EC, so provides improved lithium diffusivity at lower temperature operations.

The disclosed electrolytes are formulated to increase the performance of lithium ion batteries using a silicon-based active material. The silicon-based active material is not limited except to include some form of silicon or silicon alloy that has a specific capacity of greater than 700 mAh/g. Examples of silicon-based active material can include, but are not limited to, silicon oxide (SiOₓ) materials, carbon coated silicon active materials, and silicon alloy active materials. Graphite is not used as an active material, although some carbon may be used as a conductive agent, so long as the silicon-based active material has greater than 700 mAh/g specific capacity. Conventional graphite anodes have a specific capacity of 372 mAh/g on average.

The electrochemical cells disclosed herein are unit cells, an assembly of a plurality of electrochemical cells forming a lithium ion battery. The electrochemical cells disclosed herein comprise an anode comprising a silicon-based active material, a cathode comprising a cathode active material and an electrolyte comprising the disclosed PC-based electrolyte.

The electrolytes disclosed herein comprise a solvent that does not include ethylene carbonate, the solvent being 20 wt % to 50 wt % propylene carbonate with the remainder being one or more linear solvents, a lithium salt, and less than 15 wt % of one or more additives.

The linear solvents can be one or a combination of diethyl carbonate (DEC), dimethyl carbonate (DMS) and ethyl methyl carbonate (EMC). The amounts and combinations of linear solvent with the propylene carbonate are formulated for viscosity, ionic conductivity, and electrochemical and thermal stabilities. The resulting solvent enhances both the solubility of salt and the mobility of ions, simultaneously. If the fraction of cyclic carbonate in the electrolyte increases, the solubility will also increase but the mobility of ions will undesirably decrease in general. In contrast, if the fraction of linear carbonate increases, the mobility of ions will be improved but the solubility will be worse.

The lithium salt can be lithium hexafluorophosphate (LiPF₆). The LiPF₆ can be combined with one of lithium bis(fluorosulfonyl)imide (LiFSI) or lithium bis(trifluoromethanesulfonyl)imide (LiTFSI). The molar concentration of the lithium salt is between 0.7 M to 1.5 M. All ranges provided herein are inclusive of the end values.

In embodiments of the electrochemical cell, the electrolyte may include an additive. The additive may be less than 15 wt % of the electrolyte. In some embodiments, the additive may be 10 wt % or less of the electrolyte. In some embodiments, the additive may be 5 wt % or less of the electrolyte. The additive may be one additive or a combination of additives. The additives may be, as non-limiting examples, fluoroethylene carbonate (FEC), vinylene carbonate (VC), oxalates, or nitriles. Oxalates may be used in a range of 0.2 wt % to 2.0 wt %. Nitriles may be used in a range of 1.0 wt % to 5.0 wt %. VC may be used in a range of 0.2 wt % to 3.0 wt %. FEC may be used in a range of 1.0 wt % to 10 wt %. Combinations of additives include, but are not limited to, VC and FEC, VC and FEC and oxalate, and VC and FEC and oxalate and nitrile. Non-limiting examples of oxalate-based additives include lithium bis(oxalato) borate (LiBOB) and lithium difluoro(oxalato) borate (LiDFOB). Non-limiting examples of nitrile additives include SN and hexane tricarbonitrile (HTCN).

One example of the propylene carbonate-based electrolyte consists of 1.15 M LiPF6, a solvent of 30 wt % PC and 70 wt % DEC, 5 wt % FEC, and 1 wt % VC (Electrolyte C). Electrolyte C was used with both a graphite anode and a silicon anode having no graphite. Electrolyte C was compared with Electrolyte B, an electrolyte having 20 wt % EC, as well as with Electrolyte A, an EC based electrolyte with 1M LiPF6 and additives. As expected, Electrolytes A and B, both EC-based, showed good performance with the graphite anode, and poorer performance with the silicon-based anode. Electrolyte C performed will with the silicon-based anode, and performed poorly with the graphite anode, which is expected due to exfoliation. In the examples, the silicon anode was 85% SiOₓ with carbon and binder. The testing protocol was 0.2C discharge capacity every 50^{th} cycle and 0.5C discharge capacity for the other cycles.

An aspect of the disclosed embodiments is a lithium-ion battery. The power generating element of the lithium-ion battery includes a plurality of unit electrochemical cell layers each including a cathode active material layer, an electrolyte layer having the propylene carbonate-based electrolyte as disclosed herein, and an anode active material layer containing a silicon-based active material. The cathode active material layer is formed on a cathode current collector and electrically connected thereto, and the anode active material layer is formed on an anode current collector and electrically connected thereto. The electrolyte layer can include a separator serving as a substrate, the electrolyte supported by the separator, or just the electrolyte if no separator is required.

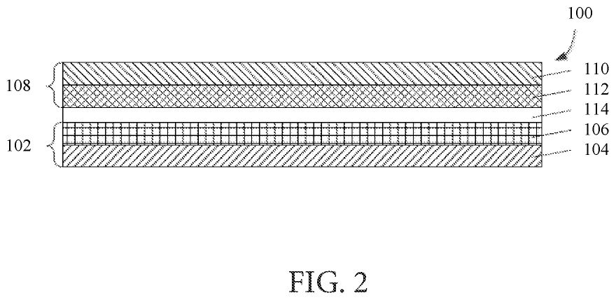

An electrochemical cell 100 is shown in cross-section in FIG. 2. The electrochemical cell 100 has an anode 102 with an anode current collector 104 and a silicon-based anode active material 106 disposed on the anode current collector 104. The lithium ion battery electrochemical cell 100 also has a cathode 108 with a cathode current collector 110 and a cathode active material 112 disposed over the cathode current collector 110. The cathode 108 and the anode 102 are separated by a separator 114, if needed, and an electrolyte as disclosed herein.

The cathode current collector 110 can be, for example, an aluminum sheet or foil. Cathode active materials 112 are those that can occlude and release lithium ions, and can include one or more oxides, chalcogenides, and lithium transition metal oxides which can be bonded together using binders and optionally conductive fillers such as carbon black. Lithium transition metal oxides can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCO_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. As needed, the cathode active material 112 can contain an electroconductive material, a binder, etc.

The anode active material 106 is a silicon-based material as previously described. The silicon-based active material is not limited except to include some form of silicon or silicon alloy that has a specific capacity of greater than 700 mAh/g. Non-limiting examples of silicon-based anode material include Si, SiOx, and Si/SiOx composites. A conducting agent may be used. Further, one or more of a binder and a solvent may be used to prepare a slurry that is applied to the current collector, for example. The anode current collector 104 can be a copper or nickel sheet or foil, as a non-limiting example.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An electrochemical cell, comprising:
an anode comprising a silicon-based active material having a specific capacity of ≥700 mAh/g;
a cathode comprising a cathode active material; and
an electrolyte comprising:
an ethylene carbonate-free solvent, the ethylene carbonate-free solvent being 20 wt % to 50 wt % propylene carbonate with the remainder being a linear solvent;
a lithium salt; and
less than 15 wt % of one or more additives.

2. The electrochemical cell of claim 1, wherein the linear solvent is one or a combination of diethyl carbonate, dimethyl carbonate or ethyl methyl carbonate.

3. The electrochemical cell of claim 1, wherein the linear solvent is one or a combination of propyl propionate or ethyl propionate.

4. The electrochemical cell of claim 1, wherein the molar concentration of the lithium salt is 0.7 M to 1.5 M.

5. The electrochemical cell of claim 1, wherein the lithium salt is LiPF₆.

6. The electrochemical cell of claim 5, wherein the lithium salt further includes LiFSI or LiTFSI.

7. The electrochemical cell of claim 1, wherein the one or more additives is fluoroethylene carbonate.

8. The electrochemical cell of claim 1, wherein the one or more additives is selected from the group consisting of fluoroethylene carbonate, vinylene carbonate, an oxalate-based additive, and a nitrile-based additive.

9. The electrochemical cell of claim 1, wherein the ethylene carbonate-free solvent is 30 wt % propylene carbonate and 70 wt % diethyl carbonate.

10. An electrochemical cell, comprising:
an anode comprising a silicon-based active material having a specific capacity of ≥700 mAh/g;
a cathode comprising a cathode active material; and
an electrolyte having no ethylene carbonate, the electrolyte comprising:
a solvent, the solvent being 30 wt % propylene carbonate and 70 wt % diethyl carbonate;
1.15 M LiPF₆; and
less than 15 wt % of one or more additives.

11. The electrochemical cell of claim 10, wherein the one or more additives are fluoroethylene carbonate and vinylene carbonate.

12. An electrochemical cell, comprising:
an anode comprising a silicon-based active material having a specific capacity of ≥700 mAh/g;
a cathode comprising a cathode active material; and
an electrolyte consisting of:
a solvent, the solvent being 20 wt % to 50 wt % propylene carbonate with the remainder being a linear solvent;
lithium salt selected from the group consisting of LiPF₆, LiPF₆ and LiFSI, or LiPF₆ and LiTFSI, the lithium salt having a molar concentration of 0.7 M to 1.5 M; and
less than 15 wt % of one or more additives.

13. The electrochemical cell of claim 12, wherein the linear solvent is one or a combination of diethyl carbonate, dimethyl carbonate or ethyl methyl carbonate.

14. The electrochemical cell of claim 12, wherein the linear solvent is one or a combination of propyl propionate or ethyl propionate.

15. The electrochemical cell of claim 12, wherein the one or more additives is fluoroethylene carbonate.

16. The electrochemical cell of claim 12, wherein the one or more additives is selected from the group consisting of fluoroethylene carbonate, vinylene carbonate, an oxalate-based additive, and a nitrile-based additive.

17. The electrochemical cell of claim 12, wherein the solvent is 30 wt % propylene carbonate and 70 wt % diethyl carbonate.
